(19) United States
(12) Patent Application Publication
(10) Pub. No.: US 2018/0058359 A1
(43) Pub. Date: Mar. 1, 2018

(54) FUEL-SYSTEM FAILURE DETECTION APPARATUS FOR ENGINE

(71) Applicant: MITSUBISHI JIDOSHA KOGYO KABUSHIKI KAISHA, Tokyo (JP)

(72) Inventors: Junya KITADA, Tokyo (JP); Hideo MATSUNAGA, Tokyo (JP); Satoshi MAEDA, Tokyo (JP)

(73) Assignee: MITSUBISHI JIDOSHA KOGYO KABUSHIKI KAISHA, Tokyo (JP)

(21) Appl. No.: 15/687,120

(22) Filed: Aug. 25, 2017

(30) Foreign Application Priority Data
Aug. 26, 2016 (JP) 2016-166015

(51) Int. Cl. F02D 41/22; F02D 41/30

(52) U.S. Cl. CPC F02D 41/22; F02D 2041/224; F02D 41/3094

(57) ABSTRACT

There is provided fuel-system failure detection apparatus applied to an engine capable of switching between a first injection mode and a second injection mode, which comprises a first failure determination unit which performs a fuel system failure determination process while the engine is operating in the first and the second injection modes, respectively, a second failure determination unit which, when the first failure determination unit gives a decision of failure while the engine is operating in either of the two injection modes, performs the fuel system failure determination process while the engine is operating in the other injection mode, and a failure identification unit which identifies a failure in fuel systems governing the first and second injection modes respectively, based on a decision about failure given by the second failure determination unit.

### BACKGROUND OF THE INVENTION

### Field of the Invention

The present invention relates to fuel-system failure detection apparatus for an engine, specifically fuel-system failure detection apparatus applied to an engine capable of switching between a plurality of injection modes.

### Description of the Related Art

A failure in a fuel system of an engine leads directly to adverse effects such as deteriorated exhaust gas characteristics caused by an inappropriate air-fuel ratio. Thus, a function of detecting a failure in the fuel system is required by law, which function may include displaying failure information when a failure is detected, to urge the driver to make repair, and storing a failure code in an ECU which controls the engine, to be of use in future repair.

With regard to conventional fuel-system failure detection apparatus applied to a port injection engine, there is a technique which focuses on an increase in A/F learned value and accumulated deviation caused by a failure in the fuel system. Fuel injection quantity for the engine is dynamically corrected based on accumulated deviation obtained by summing deviations between a target air-fuel ratio and a measured air-fuel ratio. If increase in accumulated deviation to a “rich” or a “lean” side continues over a specified period of time, the A/F leaned value, which corresponds to a stationary component of deviations between the target air-fuel ratio and the measured air-fuel ratio, is updated to correct the mid-value of output of an air-fuel ratio sensor such as an LAFS (linear A/F sensor), thereby maintaining exhaust air-fuel ratio at a target air fuel ratio.

When the fuel system is out of order, the exhaust air-fuel ratio cannot be maintained at the target air-fuel ratio even when the A/F learned value reaches a correction limit, so that correction is made based on the accumulated deviation. Accordingly, if the A/F learned value reaches a correction limit and the accumulated deviation reaches a reference value predetermined for failure determination, it is determined that the fuel system is out of order.

Apart from such conventional fuel-system failure detection apparatus, for example a patent document (Japanese Patent No. 5724963) proposes fuel-system failure detection apparatus applied to an engine capable of switching between port injection and direct injection. In the technique of the above-identified patent document, imbalance is determined based on variations in engine rpm while the engine is operating by port injection and by direct injection, respectively, and when a decision of imbalance is given in either of the two injection modes, it is determined that a component of the fuel system related to that injection mode, for example a port injector or an in-cylinder injector is out of order.

However, variations in engine rpm (imbalance), on which whether the fuel system is out of order is determined in the technique of the above-identified patent document, are caused by factors other than a failure in the fuel system itself. Such factors include an increase or decrease in intake quantity caused by deposits or leaks in an intake system and a failure in an ignition system. Such external factors, i.e., factors other than the fuel system may cause variations in rpm, and thus, lead to a decision of failure. This means that the factors which can cause a decision of failure in either of the two injection modes include external factors, i.e., factors other than a failure in the fuel system related to that injection mode.

Thus, in the technique of the above-identified patent document, the fuel system which is itself in order may be determined to be out of order because of an external factor, resulting in a false fuel-system failure code being stored. It goes without saying that even if determination is conducted again in the same injection mode as when the decision of failure was given, only the same decision is given, which does not lead to increased reliability. Such problem caused by external factors is observed also in the failure detection apparatus for the port injection engine which detects a failure based on a deviation in air-fuel ratio (accumulated deviation, increase in A/F learned value).

### SUMMARY OF THE INVENTION

The present invention has been made in order to solve the above problem. An object of the present invention is to provide fuel-system failure detection apparatus applied to an engine capable of switching between a plurality of fuel injection modes, which can exclude a false decision of failure caused by external factors, i.e., factors other than fuel systems and which can detect a failure in the fuel systems governing the respective injection modes with high reliability.

In order to achieve the above object, fuel-system failure detection apparatus applied to an engine capable of switching between a first injection mode and a second injection mode according to the present invention comprises a first failure determination unit which performs a fuel-system failure determination process while the engine is operating in the first and the second injection modes, respectively, a second failure determination unit which, when the first failure determination unit gives a decision of failure while the engine is operating in either the first or the second injection mode, performs the fuel-system failure determination process while the engine is operating in the other injection mode, and a failure identification unit which identifies a failure in fuel systems governing the first and the second injection modes respectively, based on a decision about failure given by the second failure determination unit.

In the above-described fuel-system failure detection apparatus for the engine, the fuel-system failure determination process is performed while the engine is operating in the first and the second injection modes, respectively, and when a decision of failure is given while the engine is operating in either the first or the second injection mode, then the fuel system failure determination process is performed while the engine is operating in the other injection mode. Then, based on a decision about failure given in this “other” injection mode, a failure in the fuel systems governing the first and the second injection modes respectively is identified.

At the time when a decision of failure has been given during operation in either of the two injection modes, there are not only a possibility that the decision of failure has been caused by a failure in the fuel system which governs that injection modes but also a possibility that the decision of failure has been caused by an external factor, such as a failure in an intake system or an ignition system; it cannot be determined which has caused the decision of failure. In the present invention, in this situation, the failure determination process is performed during operation in the other injection mode, and if a decision of failure is not given, it confirms not only that the fuel system related to said “other” injection mode is in order but also the absence of an external factor.

Accordingly, it can be inferred that an external factor was absent when the decision of failure was given in the former injection mode, and thus, it can be concluded that the cause of the decision of failure given in the absence of an external factor is a failure in the fuel system related to the former injection modes.

Accordingly, the fuel-system failure detection apparatus according to the present invention which is applied to an engine capable of switching between a plurality of fuel injection modes can exclude a false decision of failure caused by external factors, i.e., factors other than fuel systems, and can detect a failure in the fuel systems governing the respective injection modes with high reliability.

### BRIEF DESCRIPTION OF THE DRAWINGS

The present invention will become more fully understood from the detailed description given hereinafter and the accompanying drawings which are given by way of illustration only, and thus, are not limitative of the present invention, and wherein:

FIG. 1 is a diagram showing the overall configuration of an engine to which fuel-system failure detection apparatus in an embodiment of the present invention is applied.

FIG. 2 is part of a flowchart showing a failure determination routine performed by an ECU.

FIG. 3 is the subsequent part of the flowchart showing the failure determination routine performed by the ECU.

### DETAILED DESCRIPTION OF THE INVENTION

Fuel-system failure detection apparatus for an engine in an embodiment of the present invention will be described below.

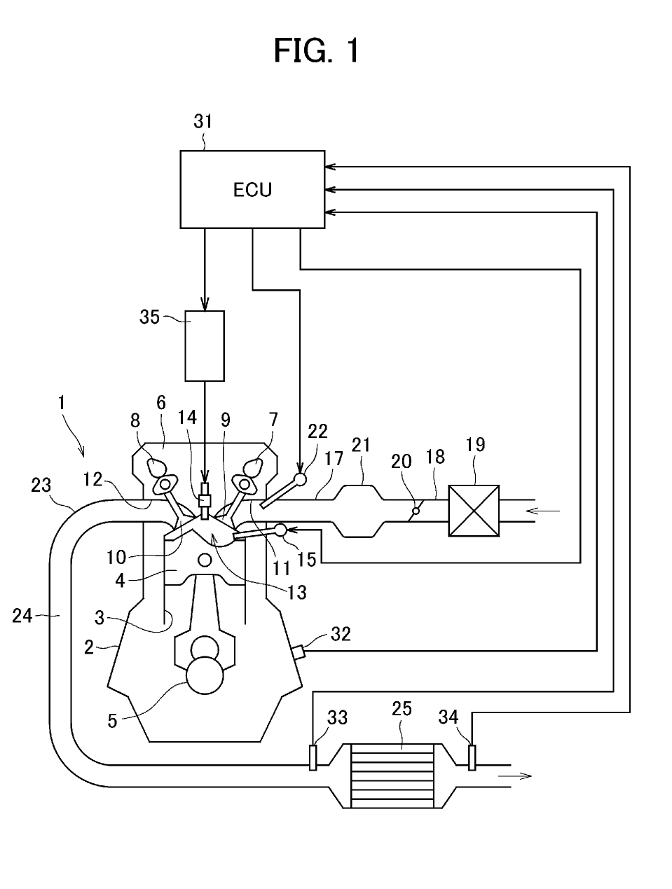

FIG. 1 is a diagram showing the overall configuration of an engine to which fuel-system failure detection apparatus in the present embodiment is applied. The engine 1 in the present embodiment is configured to be capable of switching between two injection modes, specifically a mode to conduct port injection (called “first injection mode” in the present invention and hereinafter referred to as “MPI mode”) and a mode to use port injection and direct injection in combination (called “second injection mode” in the present invention and hereinafter referred to as “MPI+DI mode”).

In cylinders 3 formed in a cylinder block 2 of the engine 1, pistons 4 are fitted, respectively. The pistons 4 slide up and down within the cylinders 3 as a crankshaft 5 rotates. An intake camshaft 7 and an exhaust camshaft 8 provided along a cylinder head 6 are driven to rotate in conjunction with the crankshaft 5. These camshafts 7, 8 drive intake valves 9 and exhaust valves 10 provided for the respective cylinders 9 to open and close respective intake ports 11 and exhaust ports 12 at predetermined crank angles. To the cylinder head 6, plugs 14 and in-cylinder injectors 15 are attached to face combustion chambers 13, respectively.

The Intake ports 11 for the respective cylinders are connected to a downstream end of an intake passage 18 by an intake manifold 17. In the intake passage 18, an air cleaner 19, a throttle valve 20, a surge tank 21 and port injectors 22 are arranged in order from the upstream side. Although not shown, fuel discharged from a feed pump is fed to the port injectors 22 at a predetermined pressure, and to the in-cylinder injectors 15 at a pressure further increased by a high pressure pump. Thus, as the port injector 22 opens, fuel is injected into the associated intake port 11, and as the in-cylinder injector 15 opens, fuel is injected into the associated combustion chamber 13 (cylinder).

Exhaust ports 12 for the respective cylinders are connected to an upstream end of an exhaust passage 24 by an exhaust manifold 23. In the exhaust passage 24, a three-way catalytic converter 25 and a muffler, not shown, are arranged.

During operation of the engine 1, air taken into the intake passage 18 through the air cleaner 19 is regulated in flow rate by the throttle valve 20, distributed by the intake manifold 17 for the respective cylinders and drawn into the respective combustion chambers 13 through the associated intake ports 11. In MPI mode, as each intake valve 9 opens, fuel injected from the associated port injector 22 is drawn into the associated combustion chamber 13 while forming a mixture with intake air. In MPI+DI mode, in addition to this, fuel is injected from each in-cylinder injector 15 directly into the associated combustion chamber 13.

In either mode, fuel is ignited by each spark plug 14 and burned within each combustion chamber 13, and pressure increased by combustion moves the pistons 4, thereby rotating the crankshaft 5. Exhaust gas produced by combustion is discharged from the respective combustion chambers 13 to the respective exhaust ports 11 as the associated exhaust valves 10 open, then collected by the exhaust manifold 23 and cleaned up by the three-way catalytic converter 25 in the exhaust passage 24, and then discharged into the atmosphere.

In the interior of the vehicle, an ECU (engine control unit) 31, which, although not shown, comprises an input/output device, a memory device (ROM, RAM, etc.) including non-volatile memory for storing control programs, control maps, etc. for a variety of control processes, described later, a central processing unit (CPU) and a timer counter, is installed to perform integrated control over the engine 1. To the input of the ECU 31, a variety of sensors including a crank angle sensor 32, an LAFS (linear air-fuel ratio sensor) 33 arranged upstream of the three-way catalytic converter 25 to detect exhaust air-fuel ratio, and an O₂ sensor (oxygen sensor) 34 arranged downstream of the three-way catalytic converter 25 to detect oxygen concentration of exhaust gas are connected. To the output of the ECU 31, a variety of devices including an igniter 35 to drive the ignition plugs 14, the aforementioned port injectors 22 and in-cylinder injectors 15 for the respective cylinders are connected.

The ECU 31 operates the engine 1 based on information detected by the sensors. For example, the ECU selects MPI mode or MPI+DI mode as an injection mode suitable for an engine operating region based on a predetermined control map, determines ignition timing, fuel injection quantity and so on in the selected injection mode, and controls operation of the igniter 35 and the injectors 15, 22 based on determined target values.

For example, in fuel injection control, the ECU 31 performs air-fuel ratio feedback to cause air-fuel ratio upstream of the three-way catalytic converter 25 to follow a target air-fuel ratio (stoichiometric ratio, for example), based on output of the LAFS 33, wherein the ECU dynamically corrects the fuel injection quantity based on accumulated deviation obtained by summing deviations between an target air-fuel ratio and an actual air-fuel ratio detected by the LAFS 33, and dynamically updates A/F learned value to correct an increase in accumulated deviation to a “rich” or a “lean” side and applies the updated A/F learned value to correction of the LAFS output. The A/F learned value is set for each injection mode. In the following description, the A/F leaned values for the respective injection modes are referred to as “MPI A/F learned value” and “DI A/F learned value”. In parallel with this, the ECU 31 performs air-fuel ratio sub-feedback based on output of the O₂ sensor 34 to apply information learned from oxygen concentration downstream of the three-way catalytic converter 25 to correction of the LAFS output.

In the present embodiment, the ECU 31 conducts failure determination about fuel systems governing MPI mode and MPI+DI mode respectively, based on the accumulated deviation between target air-fuel ratio and measured air-fuel ratio and the A/F learned value, both used in the above-described fuel injection control. More specifically, in MPI mode in which the engine operates only with the MPI fuel system, whether the MPI fuel system (multipoint injection fuel system) is out of order is determined, and in MPI+DI mode in which the engine operates by using the MPI fuel system and the DI fuel system in combination, whether the DI fuel system (direct injection fuel system) is out of order is determined, excluding the MPI fuel system.

As stated in the Description of the Related Art, the technique of the aforementioned patent document has a problem that a decision of failure is given not only when the fuel system is out of order but also when an external factor (deposits or leaks in the intake system, a failure in the ignition system, etc.) is present, leading to low reliability of failure determination.

Considering the above problem, the inventor paid attention to the fact that in the engine 1 capable of switching between two (or a plurality of) injection modes as in the present embodiment, external factors give influence in which injection mode the engine is operating, and thus, if an external factor is present, a decision of failure is given in both of the injection modes.

Specifically, when a decision of failure is given in either of the injection modes, it cannot be determined whether the decision of failure is caused by a failure in the fuel system itself or by an external factor. In this situation, however, if a failure is denied (a decision of “in order” is given) in the other fuel injection mode, it confirms not only that the fuel system governing this “other” injection mode is in order but also the absence of an external factor. The reason is: in order for the engine to properly operate in an injection mode, not only the fuel system related to that injection mode but the whole engine operating system needs to function properly. Accordingly, it can be inferred that at the time when the decision of failure was given in the former injection mode, the intake system and the ignition System were functioning properly, namely no external factor was present, and thus, it can be concluded that the decision of failure given in the absence of an external factor was caused by a failure in the fuel system related to the former injection mode.

Upon this understanding, a fuel-system failure determination process performed by the ECU 31 will be described below.

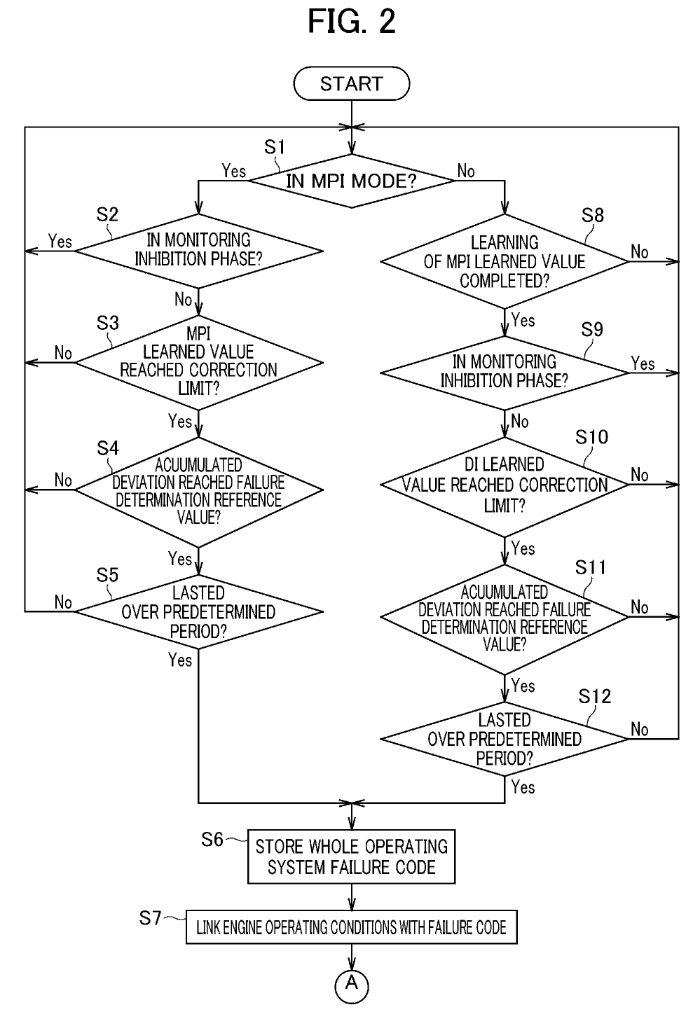

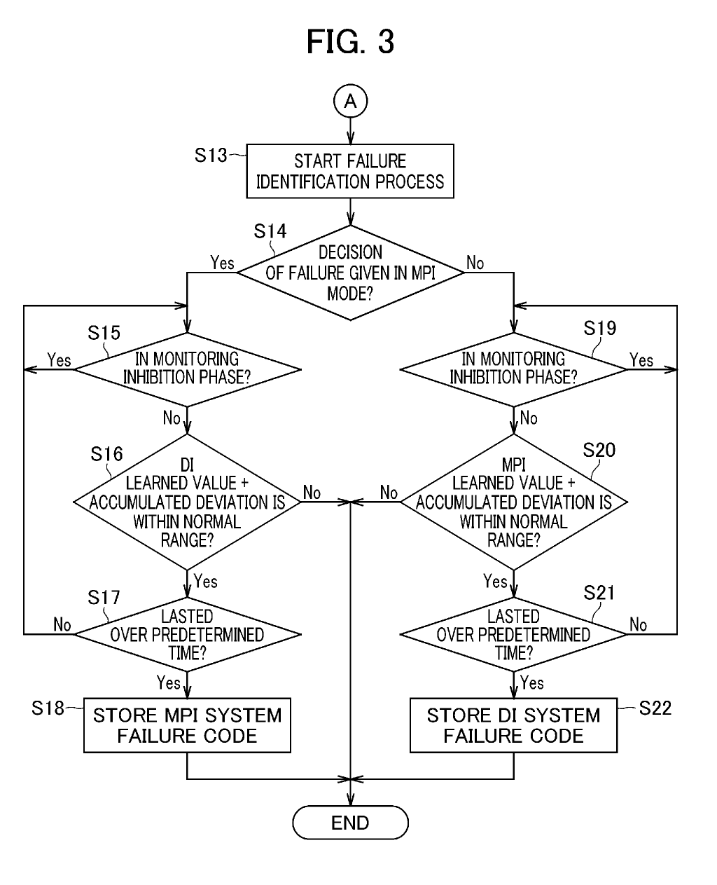

FIGS. 2 and 3 show a flowchart of a failure determination routine performed by the ECU 31. The ECU 31 performs this routine during operation of the engine 1 at predetermined control intervals.

First, at step S1, whether the engine is operating in MPI mode is determined. If the answer is Yes (affirmative), then whether the engine is in a monitoring inhibition phase is determined at step S2. Step S2 is provided to prevent a false decision caused by variations in air-fuel ratio produced immediately after a switch between the injection modes. The monitoring inhibition phase is set as a period until the air-fuel ratio experiencing temporary variations due to a switch between the injection modes stabilizes. If the answer is Yes at step S2, it means that there is a possibility of giving a false decision. Accordingly, control flow goes back to step S1. When the monitoring inhibition phase comes to an end so that the answer at step S2 changes to No (negative), control flow goes to step S3 on the assumption that there is no possibility of giving a false decision.

At step S3, whether the MPI A/F learned value has reached a predetermined correction limit is determined, and at the next step S4, whether the accumulated deviation has reached a reference value predetermined for failure determination is determined. For the MPI A/F learned value, correction limits are set on a “rich” side and a “lean” side of the mid-point 0, respectively. The range between these correction limits is a normal range which is called “first reference range” in the present invention. Likewise, for the accumulated deviation, failure determination reference values are set on a “rich” side and a “lean” side of the mid-point 0, respectively. The range between these failure determination reference values is a normal range which is called “second reference range” in the present invention.

Steps S3 and S4 are intended to conduct failure determination based on variation in MPI A/F learned value and accumulated deviation. Specifically, normally, there cannot arise a situation such that the air-fuel ratio cannot be maintained at a target air-fuel ratio although the MPI A/F leaned value reaches a correction limit on the “rich” or “lean” side and in order to make up for the deficiency, the accumulated deviation increases to the failure determination reference value on the same side. Accordingly, this situation can be considered indicative of presence of a failure. For this reason, at steps S3 and S4, whether the MPI A/F learned value and the accumulated deviation has varied to the same side is asked. For example, if it is determined at step S3 that the MPI A/F learned value has reached the correction limit on the “rich” side, then whether the accumulated deviation has reached the failure determination reference value on the “rich” side is determined at step S4.

If the answers at steps S3 and S4 are affirmative, control flow goes to step S5, where whether this situation has lasted over a predetermined period of time (5 sec, for example) is determined. If the answer is Yes, control flow goes to step S6.

At step S6, a failure code is stored. Although the decision of failure has been made in MPI mode, at this point in time there is a possibility that the decision of failure has been caused by an external factor such as a failure in the intake system or the ignition system, in addition to the possibility that the decision of failure has been caused by a failure in the MPI fuel system, and which is the cause cannot be determined. Accordingly, a failure code indicative of a “lean” or “rich” side failure (determined by to which side the MPI A/F value and the accumulated deviation have varied) in some component of the whole operating system of the engine 1 is stored.

At the next step S7, operating conditions of the engine 1 at this time, such as engine rpm Ne, charging efficiency Ec, and whether the engine has been warmed up or not, are determined and stored in a manner linked with the failure code. As described later, the operating conditions stored are used when erasing the failure code during subsequent engine operation.

If the answer is No at step S1 because the engine is operating in MPI+DI mode, control flow goes to step S8. At step S8, whether learning of the MPI A/F learned value has been completed after an on-board battery is connected is determined. This step is provided to extract a failure in the DI fuel system while the engine is operating in MPI+DI mode in which the MPI fuel system and the DI fuel system are used in combination. If learning of the MPI A/F learned value has not been completed, whether a failure is in the MPI fuel system or in the DI fuel system cannot be determined when a decision of failure is given in MPI+DI mode. If learning of the MPI A/F learned value has been completed, it confirms that the MPI fuel system is operating properly, and thus, allows an inference that the decision of failure has been caused by a failure in the DI fuel system. For this reason, the following failure determination in MPI+DI mode is conducted only if learning of the MPI A/F learned value has been completed.

If the answer is No at step S8, control flow goes back to step S1 to wait for learning of the MPI A/F learned value to be completed. When the answer at step S8 changes to Yes, control flow goes to step S9. Basically, failure determination in MPI+DI mode is similar to that in MPI mode described above. Thus, only an outline will be described below. When it is determined at step S9 that the monitoring inhibition phase is over, then whether the DI A/F learned value has reached a correction limit is determined at step S10, and whether the accumulated deviation has reached a failure determination reference value is determined at the next step S11. The correction limits and the failure determination reference values in this mode are different from those in MPI mode.

If the condition causing the answer Yes at steps S10 and S11 lasts over a predetermined period of time, the answer at step S12 is Yes, so that control flow goes to step S6. At step S6, as is the case with the failure determination in MPI mode, a failure code indicative of a “rich” or “lean” side failure in the whole operating system of the engine 1 is stored. At the next step S7, operating conditions of the engine 1 at this time are stored in a manner linked with the failure code.

In the present embodiment, in performing steps S1 to S12, the ECU 31 functions as a means called “first failure determination unit” in the present invention.

Failure determination is thus conducted while the engine is operating in MPI mode and in MPI+DI mode, respectively, and only if a decision of failure is given in either of the two modes, a process to identify what is out of order is started at step S13.

First, at step S14, whether the decision of failure was given in MPI mode is determined, and if the answer is Yes, then whether the engine is in the monitoring inhibition phase is determined at step S15. This is to prevent a false decision caused by variations in air-fuel ratio, as described with regard to steps S2 and S9. If the answer is No at step S15, then whether the sum of the DI A/F learned value updated in MPI+DI mode and the accumulated deviation is within a predetermined normal range is determined. This normal range is called “third reference range” in the present invention.

Like steps S10 and S11, step S16 is intended to conduct failure determination based on variation in DI A/F learned value and accumulated deviation, but the process is simplified. The reason is as follows: Through steps S3 and S4, it has been determined that the MPI fuel system may be out of order, although it does not allow a conclusion that the MPI is out of order. Accordingly, the purpose of step S16 is to confirm the decision given through steps S3 and S4 by denying a failure in the DI fuel system (determining that the DI fuel system is in order).

As described above, the A/F learned value is updated after increase in accumulated deviation to the “rich” or “lean” side continues over a predetermined period of time. However, update of the A/F learned value can be expected from a great increase in the A/F learned value. Considering this with the aforementioned purpose of step S16, a decision about failure may be made based on such great increase in accumulated deviation. Step S16 is executed in this view. This enables a decision about whether the DI fuel system is out of order to be made earlier, without waiting for the DI A/F learned value to be updated.

If the condition causing the answer Yes at step S16 lasts over a predetermined period of time (5 sec, for example), the answer at step S17 is Yes, so that control flow goes to step S18.

When the answers at steps S16 and S17 are Yes, it confirms not only that the DI fuel system is in order but also that an external factor, such as a failure in the intake system or the ignition system, is absent. The reason is as follows: In order that it is determined at step S16 that the sum of the A/F learned value and the accumulated deviation is within the normal range, not only the DI fuel system needs to function properly but the whole engine operating system excluding the MPI fuel system needs to function properly to control, for example intake quantity, ignition timing, etc., appropriately.

Accordingly, it can be inferred that at the time when the decision of failure was given in the previous MPI mode, the intake system and the ignition system were functioning properly, namely no external factor was present, and thus, it can be concluded that the decision of failure, given in the absence of an external factor, was caused by a failure in the MPI fuel system itself. Thus, at step S18, a failure code indicative of a “lean” or “rich” side failure in the MPI fuel system is stored, and then control flow exits the routine.

If the answer is No at step S16, control flow exits the routine without proceeding to any further step. In this case, the failure code indicative of a failure in the whole operating system of the engine 1 and the engine operating conditions linked with it, stored at steps S6 and S7, are retained.

Alternatively, when the answer is No at step S16, a failure code other than that stored at step S6 may be stored. The reason is as follows: At this point in time, a decision of failure has been made in MPI mode as well as in MPI+DI mode. The possibility that the two independent fuel systems go out of order in succession is, however, fairly low. Accordingly, it can be inferred that the decisions of failure have been caused by an external factor, i.e., factor other than a failure in the fuel systems or a failure in a component shared by the two fuel systems (feed pump, for example). This narrows down components that are possibly out of order, and allows the component which is out of order to be identified as specifically as possible, thereby facilitating coping such as repair.

When the decision of failure was given in MPI+DI mode so that the answer is No at step S14, control flow goes to step S19. The subsequent steps are similar to steps S15 to S19, although failure determination is conducted about the MPI fuel system instead of the DI fuel system. Thus, only an outline will be described below. When it is determined at step S19 that the monitoring inhibition phase is over, then at step S20, whether the sum of the MPI A/F learned value updated in MPI mode and the accumulated deviation is within the normal range is determined. If the condition causing the answer Yes at step 20 lasts over a predetermined period of time, the answer at step S21 is Yes, so that control flow goes to step S22 to store a failure code indicative of a “rich” or “lean” side failure in the DI fuel system. If the answer is No at step S20, control flow exits the routine without proceeding to any further step.

In the present embodiment, in performing steps S15 to S17 and steps S19 to S21, the ECU 31 functions as a means called “second failure determination unit” in the present invention, and in performing steps S18 and S22, the ECU 31 functions as a means called “failure identification unit” in the present invention.

Based on the failure code stored in the ECU 31 by the above-described processing, failure information is displayed to urge the driver to make repair, and a sales company or the like carries out coping such as repair referring to the failure code.

If a decision of failure is not given during the subsequent engine operation, the failure code stored in the ECU 31 is erased. The condition for erasing a failure code indicative of a failure in the whole operating system of the engine 1 stored at step S6 is different from the condition for erasing a failure code indicative of a failure in the MPI fuel system or the DI fuel system stored at step S18 or S22.

In order to erase a failure code indicative of a failure in the MPI fuel system or the DI fuel system, it is required that a decision of “no failure” be given in the injection mode corresponding to that injection system. Specifically, a failure code indicative of a failure in the MPI fuel system is erased when a decision of failure is not given in MPI mode, and a failure code indicative of a failure in the DI fuel system is erased when a decision of failure is not given in MPI+DI mode.

By contrast, a failure code indicative of a failure in the whole operating system of the engine 1 (referred to as “whole operating system failure code”) is erased when in either MPI mode or MPI+DI mode, a decision of failure is not made, subject to the condition that the engine operating conditions be similar to those stored. The condition that the engine operating conditions be similar is applied in order to prevent a failure code from being improperly erased in far different operating conditions, thereby ensuring proper erasing of a failure code.

Erasing of the whole operating system failure code does not depend on the injection mode. This is based on the understanding that erasing of the whole operating system failure code should not be limited to a specified injection mode because the failure is merely identified as a failure in some component of the whole operating system. Suppose that erasing of the whole operating system failure code is limited to a specified injection mode. Even if the failure code is false, it is not erased until the engine operates in that specified injection mode. Erasing a failure code not depending on the injection mode allows a false failure code to be erased in either of the injection modes, leading to an advantage that a false failure code is eased quickly.

In the present embodiment, in setting a failure code at steps S6, S7, S18 and S22 as well as in erasing the set failure code, the ECU 31 functions as a failure code setting unit.

As described above, in the fuel-system failure detection apparatus for the engine 1 in the present embodiment, if a decision of failure is given in either MPI mode or MPI+DI mode, then whether the fuel system related to the other injection mode is in order is determined, and if it is confirmed that the fuel system related to this “other” fuel mode is in order, then it is concluded that the fuel system related to the former injection mode in which the decision of failure was given is out of order, because the confirmation that the other fuel system is in order also supports the absence of an external factor. Thus, without influence of external factors, it can be concluded that a fuel system related to one of the injection modes is out of order. This drastically increases reliability of failure determination.

In the above, an embodiment of the present invention has been described. The present invention is however not limited to the described embodiment. For example, in the described embodiment, the present invention is applied to the engine 1 capable of switching between two injection modes, MPI mode for multipoint injection and MPI+DI mode for combined use of multiport injection and direct injection. The injection modes are however not limited to these. For example, the present invention may be applied to an engine capable of switching between diffusion combustion mode in which fuel diffused is burned in the cylinders of the engine 1 and premixing combustion mode in which fuel premixted with air is burned. Further, the present invention may be applied to an engine comprising a pair of port injectors for each intake port and capable of switching between an injection mode in which only one of the paired injectors is driven and an injection mode in which both the paired injectors are driven. Furthermore, the present invention may be applied to an engine capable of switching between three or more injection modes.

In the described embodiment, fuel system failure determination is conducted based on deviation in air-fuel ratio in the engine 1. Failure determination is however not limited to this method. For example, failure determination is conducted based on variation in engine rpm as in the technique of the aforementioned patent document. Further, the first failure determination unit and the second failure determination unit may employ different failure determination methods.

What is claimed is:

1. Fuel-system failure detection apparatus applied to an engine capable of switching between a first injection mode and a second injection mode, comprising:
a first failure determination unit which performs a fuel system failure determination process while the engine is operating in the first and the second injection modes, respectively,
a second failure determination unit which, when the first failure determination unit gives a decision of failure while the engine is operating in either of the two injection modes, performs the fuel system failure determination process while the engine is operating in the other injection mode, and
a failure identification unit which identifies a failure in fuel systems governing the first and second injection modes respectively, based on a decision about failure given by the second failure determination unit.

2. The fuel-system failure detection apparatus according to claim 1, wherein
when the second failure determination unit does not give a decision of failure, the failure identification unit concludes that the fuel system governing the injection mode in which the first failure determination unit has given the decision of failure is out of order, and when the second failure determination unit gives a decision of failure, the failure identification unit determines that some component of a whole engine operating system including the fuel systems is out of order.

3. The fuel-system failure detection apparatus according to claim 2, further comprising
a failure code setting unit which, when the first failure determination unit gives a decision of failure while the engine is operating in either of the two injection modes, stores a failure code indicative of a failure in the whole engine operating system, and after that if the first failure determination unit does not give a decision of failure while the engine is operating in either the first or the second injection mode, erases the stored failure code.

4. The fuel-system failure detection apparatus according to claim 3, wherein
the failure code setting unit stores operating conditions of the engine at the time when the failure code is stored, in a manner linked with the failure code, and after that if the first failure determination unit does not give a decision of failure in operating conditions similar to those stored, erases the stored failure code.

5. The fuel-system failure detection apparatus according to claim 1, wherein
the first and the second failure determination units perform the fuel system failure determination process based on accumulated deviation obtained by summing deviations between a target air-fuel ratio and a measured air-fuel ratio in fuel injection control for the engine and air-fuel ratio learned value corresponding to a stationary component of deviations between the target air-fuel ratio and the measured air-fuel ratio.

6. The fuel-system failure detection apparatus according to claim 5, wherein
the first failure determination unit gives a decision of failure when the air-fuel ratio learned value deviates from a first reference range to a “rich” or a “lean” side and the accumulated deviation deviates from a second reference range to a “rich” or a “lean” side, and
the second failure determination unit gives a decision of failure when the sum of the air-fuel ratio learned value and the accumulated deviation deviates from a third reference range to a “rich” or a “lean” side.

7. The fuel-system failure detection apparatus according to claim 1, wherein
the first injection mode is port injection in which fuel is injected into intake ports, while the second injection mode is combined use of the port injection and direct injection in which fuel is injected into cylinders of the engine, and
the failure identification unit identifies a failure in a fuel system for the port injection as a fuel system governing the first injection mode and a failure in a fuel system for the direct injection as a fuel system governing the second injection mode.
